(19) United States
(12) Patent Application Publication
(10) Pub. No.: US 2026/0220827 A1
(43) Pub. Date: Jul. 30, 2026

(54) GENERATING IMAGE-BASED AVATARS USING MULTI-MODAL ARTIFICIAL INTELLIGENCE TECHNIQUES

(71) Applicant: Dell Products L.P., Round Rock, TX (US)

(72) Inventors: Zijia Wang, London (GB); Bin He, Shanghai (CN); Zhen Jia, Shanghai (CN)

(21) Appl. No.: 19/036,615

(22) Filed: Jan. 24, 2025

(51) Int. Cl. G06T 11/00

(52) U.S. Cl. CPC G06T 11/00

(57) ABSTRACT

Methods, apparatus, and processor-readable storage media for generating image-based avatars using multi-modal artificial intelligence techniques are provided herein. An example computer-implemented method includes encoding one or more image-related features by processing one or more portions of input image data using at least one multi-channel image encoder; encoding one or more audio-related features by processing one or more portions of input audio data using at least one audio encoder; encoding one or more text-related features by processing one or more portions of input text data using at least one text encoder; and generating at least one image-based avatar by processing, using at least one vision encoder, at least a portion of the one or more image-related features and one or more of at least a portion of the one or more audio-related features and at least a portion of the one or more text-related features.

### BACKGROUND

Digitally modeling a communicating human can be a potential building-block for a variety of applications. However, conventional modeling techniques fail to adequately represent various human emotions and communicative actions.

### SUMMARY

Illustrative embodiments of the disclosure provide techniques for generating image-based avatars using multi-modal artificial intelligence techniques.

An example computer-implemented method includes encoding one or more image-related features by processing one or more portions of input image data using at least one multi-channel image encoder, encoding one or more audio-related features by processing one or more portions of input audio data using at least one audio encoder, and encoding one or more text-related features by processing one or more portions of input text data using at least one text encoder. Further, the method also includes generating at least one image-based avatar by processing, using at least one vision encoder, at least a portion of the one or more image-related features and one or more of at least a portion of the one or more audio-related features and at least a portion of the one or more text-related features.

Illustrative embodiments can provide significant advantages relative to conventional modeling techniques. For example, problems associated with failure to adequately represent various human emotions and communicative actions are overcome in one or more embodiments through automatically manipulating image-based avatars by incorporating text features and/or audio features using multiple artificial intelligence-based encoder-decoders.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for generating image-based avatars using multi-modal artificial intelligence techniques in an illustrative embodiment.

FIG. 2 shows an example workflow of manipulating avatars in an illustrative embodiment.

FIG. 3 shows example architecture for a text-based encoder-decoder in an illustrative embodiment.

FIG. 4 shows example architecture for an audio-based encoder-decoder in an illustrative embodiment.

FIG. 5 shows an example architecture of a vision decoder in an illustrative embodiment.

FIG. 6 shows an example workflow of a forward loop in an illustrative embodiment.

FIG. 7 shows an example workflow of a backward loop in an illustrative embodiment.

FIG. 8 is a flow diagram of a process for generating image-based avatars using multi-modal artificial intelligence techniques in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

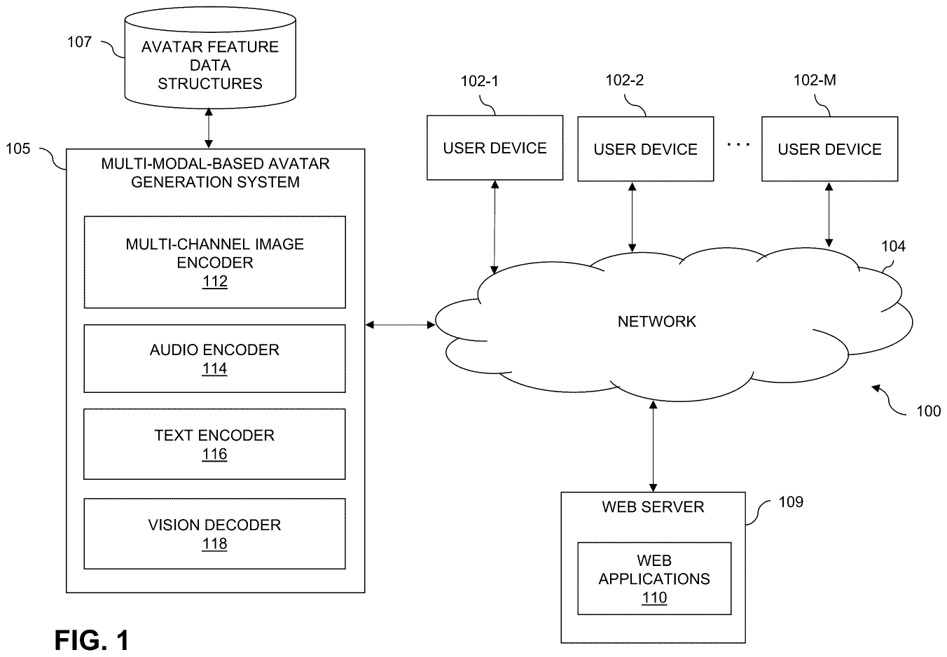

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is multi-modal-based avatar generation system 105 and web server 109, upon which one or more web applications 110 (e.g., web applications utilizing avatars such as telecommunications applications, virtual learning applications, social media applications, gaming applications, etc.) execute.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the multi-modal-based avatar generation system 105 can have one or more avatar feature data structures 107 configured to store data pertaining to image features, audio features, text features, concatenated features, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The avatar feature data structures 107 in the present embodiment are implemented using one or more storage systems associated with the multi-modal-based avatar generation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the multi-modal-based avatar generation system 105 are one or more input-output devices, which illustratively comprise keyboards, displays or other types of input-output devices in any combination. Such input-output devices can be used, for example, to support one or more user interfaces to the multi-modal-based avatar generation system 105, as well as to support communication between the multi-modal-based avatar generation system 105 and other related systems and devices not explicitly shown.

Additionally, the multi-modal-based avatar generation system 105 in the FIG. 1 embodiment is assumed to be implemented using at least one processing device. Each such processing device generally comprises at least one processor and an associated memory, and implements one or more functional modules for controlling certain features of the multi-modal-based avatar generation system 105.

More particularly, the multi-modal-based avatar generation system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the multi-modal-based avatar generation system 105 to communicate over the network 104 with the user devices 102, and illustratively comprises one or more conventional transceivers.

The multi-modal-based avatar generation system 105 further comprises multi-channel image encoder 112, audio encoder 114, text encoder 116 and vision decoder 118.

In at least one embodiment, the multi-channel image encoder 112 can be implemented to encode one or more image-related features by processing one or more portions of input image data using at least one multi-channel image encoder. Also, in such an embodiment, the audio encoder 114 can be implemented to encode one or more audio-related features by processing one or more portions of input audio data using at least one audio encoder, and the text encoder 116 can be implemented to encode one or more text-related features by processing one or more portions of input text data using at least one text encoder. Further, in such an embodiment, the vision decoder 118 can be implemented to generate at least one image-based avatar by processing, using at least one vision encoder, at least a portion of the one or more image-related features and one or more of at least a portion of the one or more audio-related features and at least a portion of the one or more text-related features.

It is to be appreciated that this particular arrangement of elements 112, 114, 116 and 118 illustrated in the multi-modal-based avatar generation system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for generating image-based avatars using multi-modal artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of multi-modal-based avatar generation system 105, avatar feature data structures 107, user device 102 and web server 109 can be on and/or part of the same processing platform.

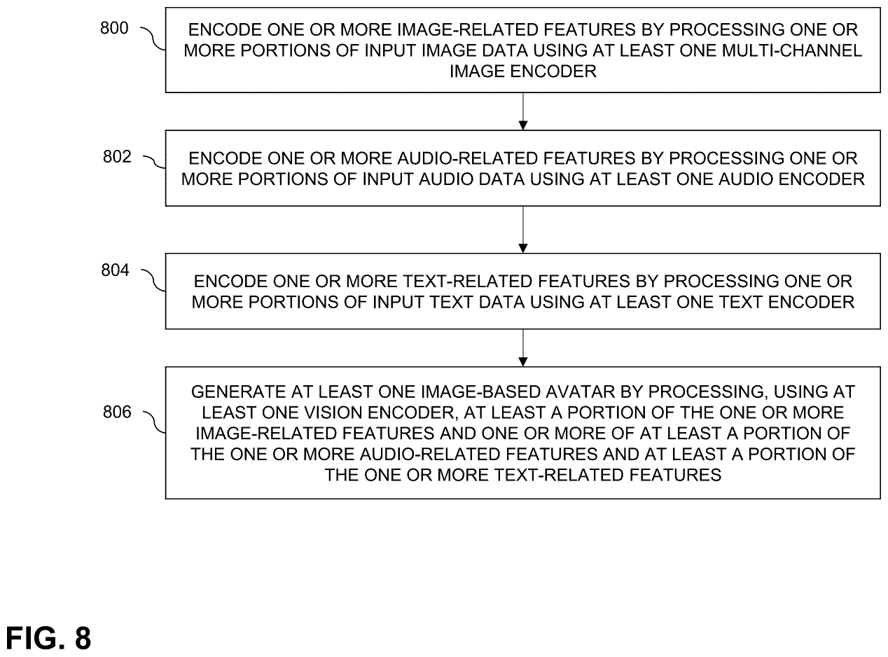

An example process utilizing elements 112, 114, 116 and 118 of an example multi-modal-based avatar generation system 105 in computer network 100 will be described in more detail with reference to the flow diagram of FIG. 8.

Accordingly, at least one embodiment includes implementing emotional text-driven avatar manipulation techniques using at least one multi-channel feature extractor. Such an embodiment includes combining audio data (also referred to herein as sound data) and text data in an image manipulation process. By combining audio data and text data to drive avatar manipulation, one or more embodiments can include enhancing an avatar (e.g., rendering the avatar more vivid) and/or implementing at least one flexibility-based change to a generated avatar.

By way of example, in at least one embodiment, text data (e.g., pertaining to one or more dialogues) and audio data are leveraged together to manipulate the avatar head. Additionally or alternatively, in one or more embodiments, text data can be leveraged in connection with generating a description of the avatar and audio data can be leveraged to control and/or manipulate the expression of the generated avatar.

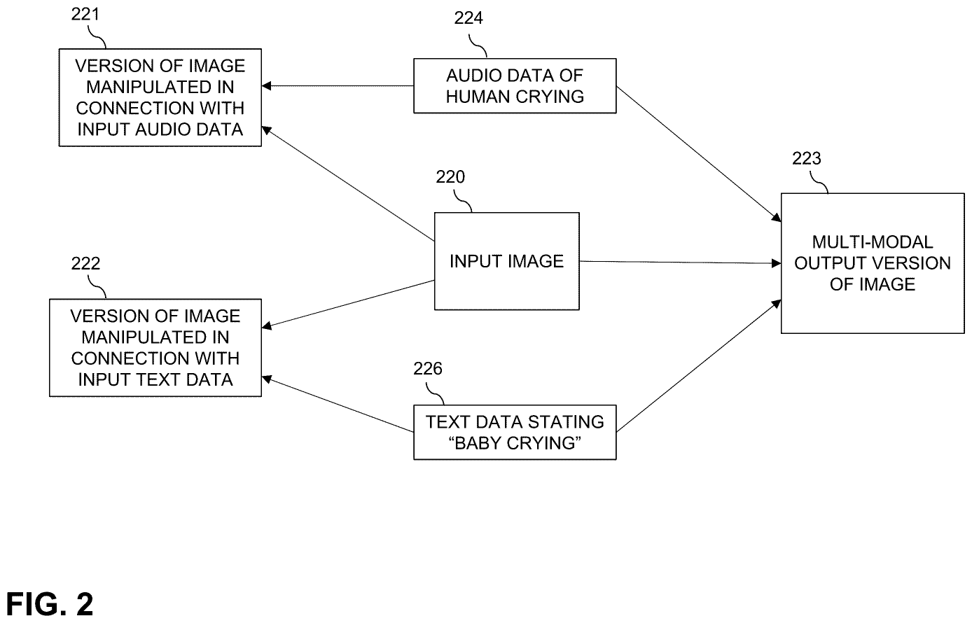

FIG. 2 shows an example workflow of manipulating avatars in an illustrative embodiment. By way of illustration, FIG. 2 depicts an input image 220, a version of the image 222 manipulated in connection with input text data (namely, input text data of “baby crying” 226), and a version of the image 221 manipulated in connection with input audio data (namely, input audio data of human crying 224). Additionally, FIG. 2 depicts a multi-modal output version of the image 223 manipulated using multi-modal processing techniques based at least in part on the version of the image 222 manipulated in connection with input text data 226 and the version of the image 221 manipulated in connection with input audio data 224.

Accordingly, FIG. 2 depicts an example embodiment which includes generating avatars based at least in part on multiple modals (original input image data, input text data, and input audio data). As detailed herein, such an example embodiment can be carried out using at least one algorithm based on an adjustable end-to-end multimodal encoder.

Further, one or more embodiments include generating at least one avatar by processing emotional-based and/or action-based audio data and text data, in addition to input image data. Such an embodiment includes implementing at least one multi-channel multi-modal encoder, which can be trained using a cyclic training strategy with adversarial loss.

In such an embodiment, a text encoder and decoder can include a system accumulating information composed of similar units repeated over time, wherein such a system encompasses a recurrent neural network (RNN). In general, a text encoder turns text data into at least one numeric representation, and this task can be implemented, in at least one embodiment, using one or more RNN encoders. Also, unlike encoders, decoders unfold at least one vector representing a sequence state and return one or more outputs such as, for example, text, tags, labels, etc. Another distinction from encoders is that decoders require both the hidden state and the output from the previous state.

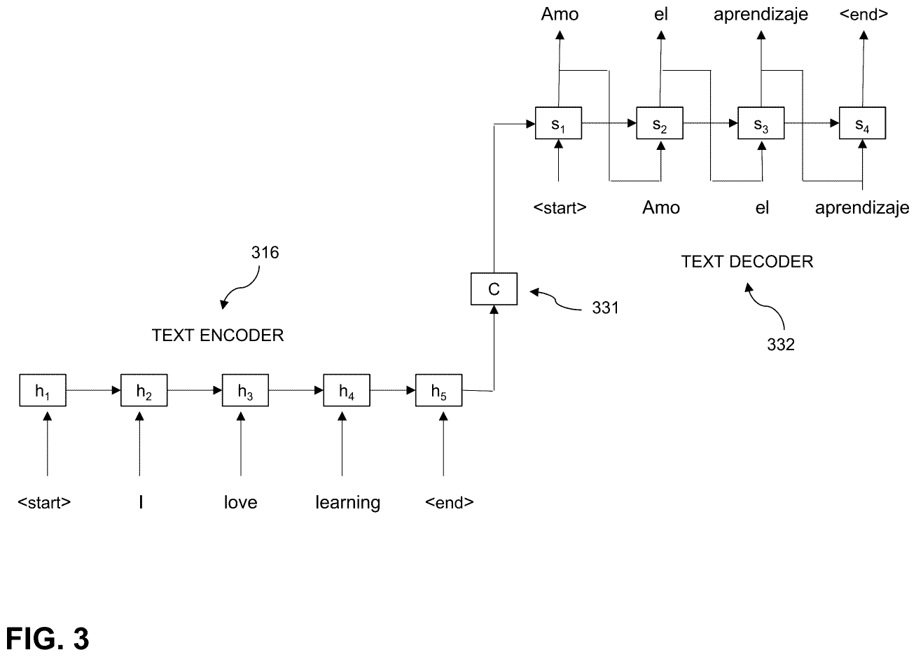

FIG. 3 shows example architecture for a text-based encoder-decoder in an illustrative embodiment. In certain use cases, when a text decoder 332 starts processing, there is no previous output, so a <start> token is used for those cases. Alternatively, as also depicted in FIG. 3, text encoder 316 can process multiple portions and/or words of a sentence, across elements h₁, h₂, h₃, h₄ and h₅, and produce state C 331 representing the sentence (e.g., “I love learning”) in a designated source language (e.g., English). Then, the text decoder 332 unfolded that state C 331, across elements s₁, s₂, s₃, and s₄, into a version of the sentence in a target language (e.g., Spanish; Amo el aprendizaje). In one or more embodiments, state C 331 can be considered a vectorized representation of the entire sequence. In other words, the text encoder 316 can be used as an approximate means to obtain embeddings from a text of arbitrary length.

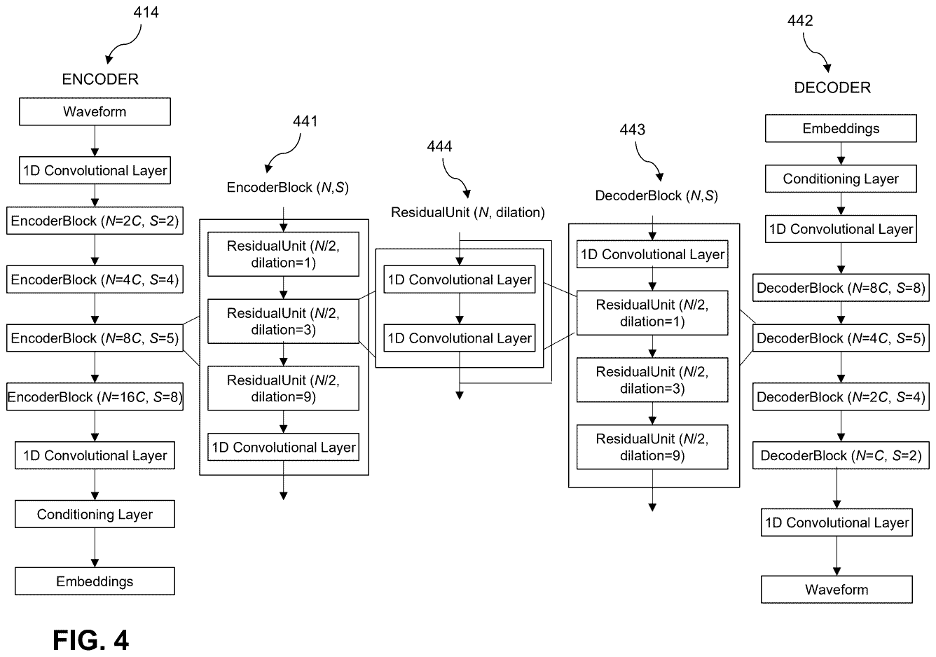

FIG. 4 shows example architecture for an audio-based encoder-decoder in an illustrative embodiment. By way of illustration, FIG. 4 depicts an encoder 414 which includes at least one one-dimensional (1D) convolution layer (with C_{enc} channels), followed by multiple B_{enc} convolution blocks. Each of the B_{enc} convolution blocks, as depicted in example B_{enc} convolution block 441 (including a dynamic number of channels, N, and a stride of the convolution layer in each given block, S), includes three residual units, containing dilated convolutions with dilation rates of 1, 3, and 9, respectively, followed by a down-sampling layer in the form of a strided convolution. In one or more embodiments, the number of channels is doubled when down-sampling, starting from C_{enc}. Referring again to encoder 414, a final 1D convolution layer, with a kernel of length 3 and a stride of 1, and a feature-wise linear modulation (FILM) conditioning layer, are used to set the dimensionality of the embeddings to decoder (D) 442.

Also, in at least one embodiment, to guarantee real-time inference, all convolutions are causal, meaning that padding is applied to the past but not the future, in both training and offline inference, whereas no padding is used in streaming inference. Such an embodiment can also include using an exponential linear unit (ELU) activation without the application of any normalization. In one or more embodiments, the number of B_{enc} convolution blocks and the corresponding striding sequence determines the temporal resampling ratio between the input waveform and the embeddings. For example, when B_{enc}=4 and using (2, 4, 5, and 8) as strides, one embedding is computed every M=2·4·5·8=320 input samples. Thus, the encoder 414 outputs enc(x)∈R_{3×D}, with S=T/M, wherein R represents the temporal resampling ratio, which determines how input samples are mapped to embeddings, and wherein T denotes the total number of input samples in the waveform, which also represents the temporal length of the input signal.

Referring again to FIG. 4, the decoder 442 architecture follows a similar design to that of the encoder 414, including a 1D convolution layer followed by a sequence of B_{dec} convolution blocks. Each decoder block, as depicted in example B_{dec} convolution block 443, includes a transposed convolution for up-sampling followed by three residual units (e.g., the same three residual units as found in encoder block 441), with an example residual unit depicted in FIG. 4 as residual unit 444. Also, the decoder 442 uses the same strides as the encoder 414, but in reverse order, to reconstruct a waveform with the same resolution as the input waveform.

Also, in at least one embodiment, the number of channels is halved when up-sampling, such that the last decoder block outputs C_{dec} channels. A final 1D convolution layer (e.g., as depicted in residual unit 444), with one filter, a kernel of size 7, and a stride of 1, projects the embeddings back to the waveform domain to produce \hat{x}. In this context, \hat{x} refers to the reconstructed waveform produced by the decoder, and it is the output of the final layer of the decoder, which projects the embeddings back into the waveform domain. This reconstructed waveform is intended to approximate the original input waveform x, completing the end-to-end encoding and decoding process. Also, in the example embodiment depicted in FIG. 4, the same number of channels in both the encoder 414 and the decoder 442 is controlled by the same parameter, i.e., C_{enc}=C_{dec}=C.

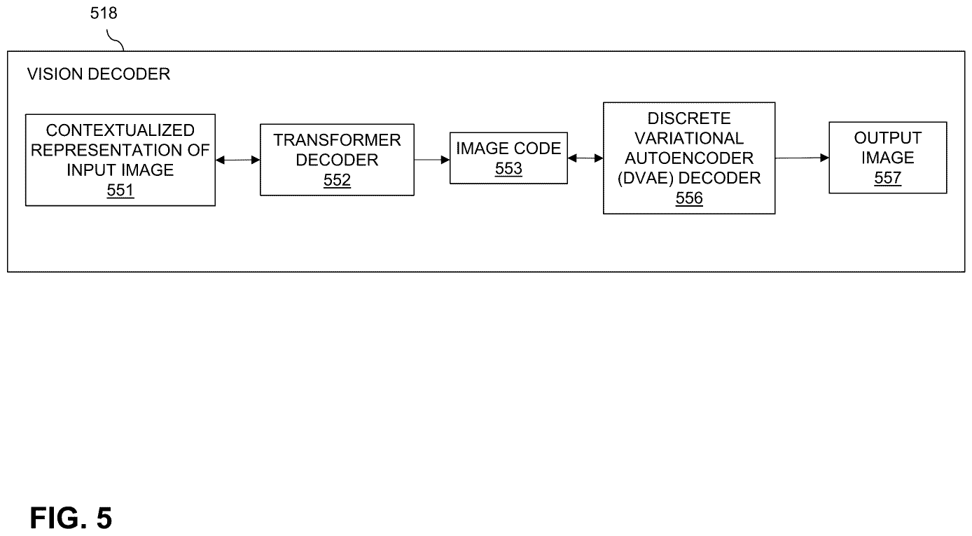

FIG. 5 shows an example architecture of a vision decoder in an illustrative embodiment. By way of illustration, FIG. 5 depicts an example vision decoder 518 which includes a transformer decoder 552 that learns at least one image code 553, and a pretrained discrete variational autoencoder (DVAE) decoder 556 that generates an output image 557. The vision decoder 518 is trained to learn to reconstruct an input image, by processing a contextualized representation of the input image 551 (e.g., at least one matrix of concatenated features derived from image-based features, audio-based features, and text-based features) using the transformer decoder 552 to generate a sequence of at least one image code 553. The image code 553 can be processed using at least one embedding space to generate an intermediate output, which is then processed by DVAE decoder 556 as part of generating the output image 557.

As also detailed herein, one or more embodiments include implementing cyclic training in connection with learning mapping functions between various domains. More particularly, in cyclic training, one objective includes learning one or more mapping functions between two domains, denoted here as X and Y. Training samples can be obtained from each domain, wherein the training samples are represented as xᵢi=1^{N} and yⱼj=1^{M}, respectively, wherein xᵢ belongs to domain X and yⱼ belongs to domain Y. In such an embodiment, i represents an index for training samples from domain X, identifying individual samples in domain X. Also, j represents an index for training samples from domain Y, identifying individual samples in domain Y. Further, N represents the total number of training samples (that is, the size of the dataset) in domain X, and M represents the total number of training samples (that is, the size of the dataset) in domain Y. Also, in such an embodiment, an objective includes training at least one X→Y mapping (also referred to herein as mapping function G) and training at least one Y→X mapping (also referred to herein as mapping function F).

To achieve these trained mappings, at least one embodiment includes using adversarial discriminators, D_{X} and D_{Y}, wherein D_{X} discriminates between real images x and translated images F(y), while D_{Y} distinguishes between real images y and generated images G(x). An objective of the model being trained, in connection with such an embodiment, includes adversarial losses, which ensure that the generated images match the target domain's data distribution, and cycle consistency losses, which prevent contradictions between the learned mapping functions G and F.

The adversarial loss for mapping function G and its discriminator D_{Y} can be expressed as follows in Equation (1):

$${L}_{G A N} ( G , {D}_{Y} , X , Y ) = \text{?} [ log {D}_{Y} ( y ) ] + \text{?} [ log ( 1 - {D}_{Y} ( G ( x ) ) ) ] \qquad ( 1 )$$

In the above-noted Equation (1), G aims to generate images G(x) that are indistinguishable from the images in domain Y, while D_{Y} attempts to differentiate between translated samples G(x) and real samples y. Also, as used herein, [symbol] represents the expected value of the real data sampled from the real data distribution associated with real images y, and [symbol] represents the expected value of the real data sampled from the real data distribution associated with real images x. Additionally, one or more embodiments include attempting to minimize this objective against an adversary D_{Y} that attempts to maximize the objective, i.e., min_{G} max D_{Y} L_{GAN}(G, D_{Y}, X, Y). Similarly, at least one embodiment can include introducing a similar adversarial loss for the mapping function F and its discriminator D_{X}, i.e., min_{F} max_{D}_{_{X}} L_{GAN}(G, D_{X}, X, Y).

The cycle consistency losses aim to further regularize mapping functions G and F by ensuring that the translated images can be transformed back to their original domain. The forward cycle consistency loss can be defined as follows in Equation (2):

$${L}_{c y c} ( G , F ) = \text{?} [ ‖ F ( G ( x ) ) - x ‖ 1 ] + \text{?} [ ‖ F ( G ( y ) ) - y ‖ 1 ] \qquad ( 2 )$$

A goal of this loss is to ensure that each input image x can be translated to the target domain Y and then back to its original domain X, yielding a reconstructed image similar to the original.

Also, one or more embodiments include applying the adversarial loss and discriminators only in the forward loop. Further, such an embodiment can include incorporating one or more additional regularization techniques and/or introducing one or more multi-domain mappings, which can enhance the training process and improve the quality of the generated outputs.

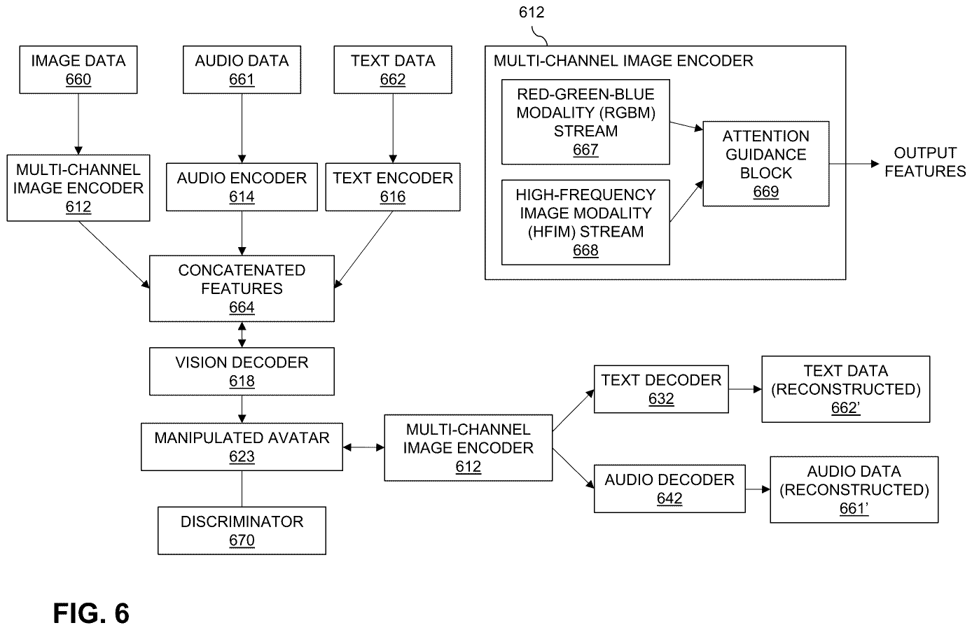

FIG. 6 shows an example workflow of a forward loop in an illustrative embodiment. By way of illustration, FIG. 6 depicts a forward loop of an example multi-modal avatar manipulation architecture as detailed herein. More particularly, image data 660, audio data 661 and text data 662 are input to multi-channel image encoder 612, audio encoder 614, and text encoder 616, respectively, then the encoded features are concatenated (creating concatenated features 664) and processed by input vision decoder 618 to generate the manipulated avatar 623. A forward discriminator (D_{Y}) 670 processes the manipulated avatar 623 to determine the accuracy and/or authenticity of the image. Then, the manipulated avatar 623 is input to the multi-channel image encoder 612 again, to generate encoded features, and at least a portion of the encoded features are input to text decoder 632 and audio decoder 642 to reconstruct text 662′ and audio 661′ as used in connection with generating the manipulated avatar 623.

Accordingly, using an example forward loop such as depicted in FIG. 6, at least one embodiment includes generating a manipulated avatar by manipulating image data 660, audio data 661, and text data 662 inputs. The process, in such an embodiment, involves separate encoders for each modality (e.g., multi-channel image encoder 612, audio encoder 614, and text encoder 616, respectively), followed by concatenation of the encoded features. These concatenated features 664 are then fed into the vision decoder 618, which generates the manipulated avatar 623. To assess the authenticity of the generated image (i.e., the manipulated avatar 623), forward discriminator (D_{Y}) 670 is employed. The manipulated avatar 623 is then passed through the multi-channel image encoder 612 again, and the encoded features are used by the text decoder 632 and the audio decoder 642 to reconstruct text 662′ and audio 661′.

As detailed in connection with FIG. 6, to enhance the detection of manipulated images, at least one embodiment includes using a multi-channel image encoder 612 that incorporates a red-green-blue (RGB) modality (RGBM) stream 667, a high-frequency image modality (HFIM) stream 668, and an attention guidance block 669. Conventional methods have shown that tampering artifacts are often concealed at the boundary between the tampered region and the original picture area. In the frequency domain, image edges are represented as high-frequency information. Therefore, one or more embodiments include adopting a two-stream architecture, wherein the first stream is an RGBM stream 667 including a convolutional neural network (CNN) that learns the content features of the image. The second stream, the HFIM stream 668, focuses on learning one or more high-frequency features by using a constraint convolutional layer to filter the image and extract one or more prediction errors, resulting in high-frequency images. One or more subsequent convolutional layers are then applied to extract high-frequency features from these images.

To guide the RGBM stream 667 to learn one or more tampering artifacts effectively, at least one embodiment includes introduces an attention mechanism implemented via a convolutional block attention module (CBAM) in connection with attention guidance block 669. In such an embodiment, attention guidance block 669 incorporates spatial and channel attention processes, providing instructions for the RGBM stream 667 to prioritize learning tampering artifacts. Additionally, in at least one embodiment, the RGBM stream 667 can utilize the first three blocks of ResNet-50 (i.e., an example CNN). To ensure consistent feature map sizes for both streams, the convolutional layers in the HFIM stream 668 are designed and/or configured with careful consideration of kernel sizes and strides. For example, Conv_3, one of the shallow convolutional layers, can be used in guiding the RGBM stream 667. In such an embodiment, shallow layers can capture high-frequency features that may contain noise, while deep layers can capture higher-level features with less high-frequency information.

For the attention mechanism, at least one embodiment includes computing channel attention weights a_{c} and spatial attention weights aₛ. The channel attention weights can be computed, for example, by applying average-pooling and max-pooling operations to the feature map of the Conv_3 layer in the HFIM stream 668. These pooled results are then passed through a sigmoid activation function to obtain the final channel attention weights. Similarly, the spatial attention weights can be computed, for example, using average-pooling and max-pooling operations along the channel axis, followed by a convolution operation with a 7×7 filter size and a sigmoid activation function. Further, the guided feature map F_{rgb-att} can be obtained by element-wise multiplication of the original RGB feature map with the channel attention weights a_{c} and the spatial attention weights aₛ.

By employing this attention mechanism, the RGBM stream 667 is directed to focus more on learning tampering artifacts, leveraging the high-frequency information provided by the HFIM stream 668. This approach enhances the learning of tampering-related features and improves the detection of manipulated images. It is to be appreciated that the embodiment detailed in connection with FIG. 6 is merely an example, and other configurations and/or implementations can be carried out. For example, advanced attention mechanisms and/or alternative architectures for the RGBM and HFIM streams can be used. Additionally or alternatively, additional regularization techniques and/or leveraging self-supervised learning methods can be incorporated in an attempt to enhance the performance of the forward loop.

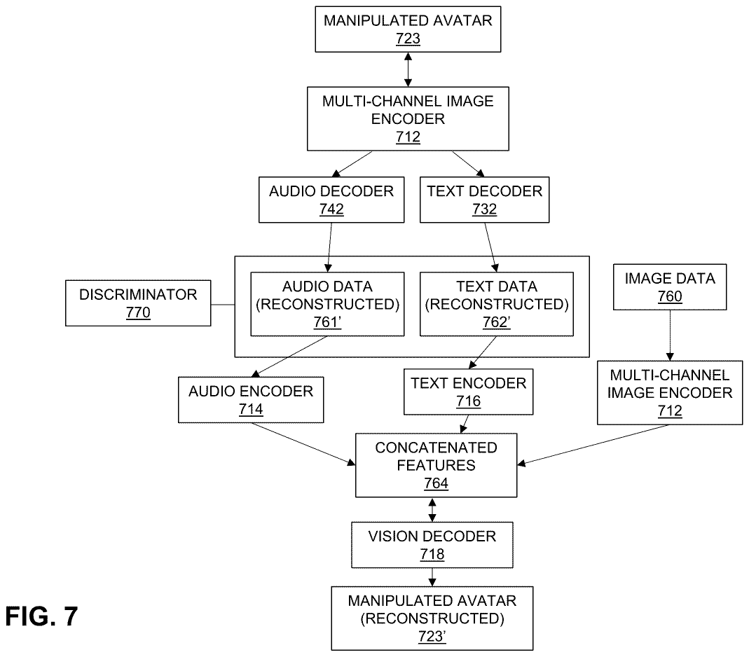

FIG. 7 shows an example workflow of a backward loop in an illustrative embodiment. By way of illustration, FIG. 7 depicts an example workflow of the backward loop of an example multi-modal avatar manipulation architecture as detailed herein, wherein the workflow is similar to that of the forward loop, except that the backward discriminator (D_{X}) 770 should aim to identify if the audio and/or text are reconstructed. More particularly, as depicted in FIG. 7, manipulated avatar 723 (such as generated using the techniques depicted in FIG. 6) is processed by multi-channel image encoder 712, and the encoded features are used by the text decoder 732 and the audio decoder 742 to reconstruct text 762′ and audio 761′, respectively. Reconstructed text 762′ and audio 761′ are then processed by backward discriminator (D_{X}) 770 to confirm that the audio and/or text are reconstructed. Upon such confirmation, reconstructed text 762′ and audio 761′ are processed by text encoder 716 and audio encoder 714, respectively, and image 760 is processed by multi-channel image encoder 712. Then, the encoded features are concatenated (creating concatenated features 764) and processed by vision decoder 718 to generate a reconstructed version manipulated avatar 723′.

Accordingly, in at least one embodiment, a training objective, including the backward discriminator (D_{X}) 770, can be illustrated as follows in Equation (3):

$$L ( G , F , {D}_{X} , {D}_{Y} ) = {L}_{G A N} ( G , {D}_{Y} , X , Y ) + {L}_{G A N} ( F , {D}_{X} , Y , X ) + λ {L}_{c y c} ( G , F ) \qquad ( 3 )$$

wherein λ controls the relative importance of the two objectived. Further, at least one embodiment includes attempt to solve the following, Equation (4):

$${G}^{*} , {F}^{*} = arg min {max}_{G , F , {D}_{X} , {D}_{Y}} L ( G , F , {D}_{X} , {D}_{Y} ) \qquad ( 4 )$$

Accordingly, in one or more embodiments, the multi-modal avatar manipulation model used herein can be viewed as training two autoencoders: one autoencoder F∘G: X→X jointly with another autoencoder G∘F: Y→Y. However, these autoencoders each have special internal structures, as they map an image to itself via an intermediate representation that is a translation of the image into another domain. Such a setup can also be seen as a special case of adversarial autoencoders, which use an adversarial loss to train the bottleneck layer of an autoencoder to match an arbitrary target distribution. In one example embodiment, the target distribution for the X→X autoencoder is that of the domain Y.

FIG. 8 is a flow diagram of a process for generating image-based avatars using multi-modal artificial intelligence techniques in an illustrative embodiment. It is to be understood that this particular process is only an example, and additional or alternative processes can be carried out in other embodiments.

In this embodiment, the process includes steps 800 through 806. These steps are assumed to be performed by the multi-modal-based avatar generation system 105 utilizing elements 112, 114, 116 and 118.

Step 800 includes encoding one or more image-related features by processing one or more portions of input image data using at least one multi-channel image encoder. In at least one embodiment, encoding one or more image-related features includes processing one or more portions of input image data using, as part of the at least one multi-channel image encoder, one or more RGBM techniques, one or more HFIM techniques, and one or more attention-guided feature learning techniques. In such an embodiment, processing one or more portions of input image data using one or more RGBM techniques can include learning one or more content-related features of the one or more portions of input image data using at least one CNN. Additionally, in such an embodiment, processing one or more portions of input image data using one or more HFIM techniques can include learning one or more high-frequency features of the one or more portions of input image data by filtering the one or more portions of input image data using at least one constraint convolutional layer and extracting one or more prediction errors based at least in part on the filtering of the one or more portions of input image data. Further, in such an embodiment, processing one or more portions of input image data using one or more attention-guided feature learning techniques can include learning one or more tampering artifacts in the one or more portions of input image data by processing the one or more portions of input image data using at least one CBAM in conjunction with one or more spatial attention processes and one or more channel attention processes.

Step 802 includes encoding one or more audio-related features by processing one or more portions of input audio data using at least one audio encoder. In one or more embodiments, encoding one or more audio-related features includes processing the one or more portions of input audio data using at least one 1D convolution layer and multiple convolution blocks, wherein each of the multiple convolution blocks includes one or more residual units, containing one or more dilated convolutions with one or more dilation rates, and at least one down-sampling layer comprising a strided convolution.

Step 804 includes encoding one or more text-related features by processing one or more portions of input text data using at least one text encoder. In at least one embodiment, encoding one or more text-related features includes converting at least part of the one or more portions of input text data into one or more numeric representations using at least one RNN-based encoder.

Step 806 includes generating at least one image-based avatar by processing, using at least one vision encoder, at least a portion of the one or more image-related features and one or more of at least a portion of the one or more audio-related features and at least a portion of the one or more text-related features. In one or more embodiments, generating at least one image-based avatar includes processing, at least a portion of the one or more image-related features and one or more of at least a portion of the one or more audio-related features and at least a portion of the one or more text-related features, using at least one transformer decoder to generate at least one image code, and generating at least one output image comprising at least a portion of the at least one image-based avatar by processing the at least one image code using at least one DVAE decoder.

In at least one embodiment, the techniques depicted in FIG. 8 can include concatenating, into at least one matrix, at least a portion of the one or more image-related features, at least a portion of the one or more audio-related features and at least a portion of the one or more text-related features. In such an embodiment, generating at least one image-based avatar includes processing the at least one matrix using the at least one vision encoder.

Also, in one or more embodiments, the techniques depicted in FIG. 8 can include performing one or more automated actions based at least in part on the at least one image-based avatar. In such an embodiment, performing one or more automated actions can include automatically training, using feedback related to the at least one image-based avatar, at least a portion of one or more of the at least one multi-channel image encoder, the at least one audio encoder, the at least one text encoder, and the at least one vision encoder. Additionally or alternatively, performing one or more automated actions can include automatically transmitting the at least one image-based avatar to at least one user device associated with one or more of the input image data, the input audio data, and the input text data.

Accordingly, the particular processing operations and other functionality described in conjunction with the flow diagram of FIG. 8 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically manipulate image-based avatars by incorporating text features and/or audio features using multiple artificial intelligence-based encoder-decoders. These and other embodiments can effectively overcome problems associated with failure to adequately represent various human emotions and communicative actions.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

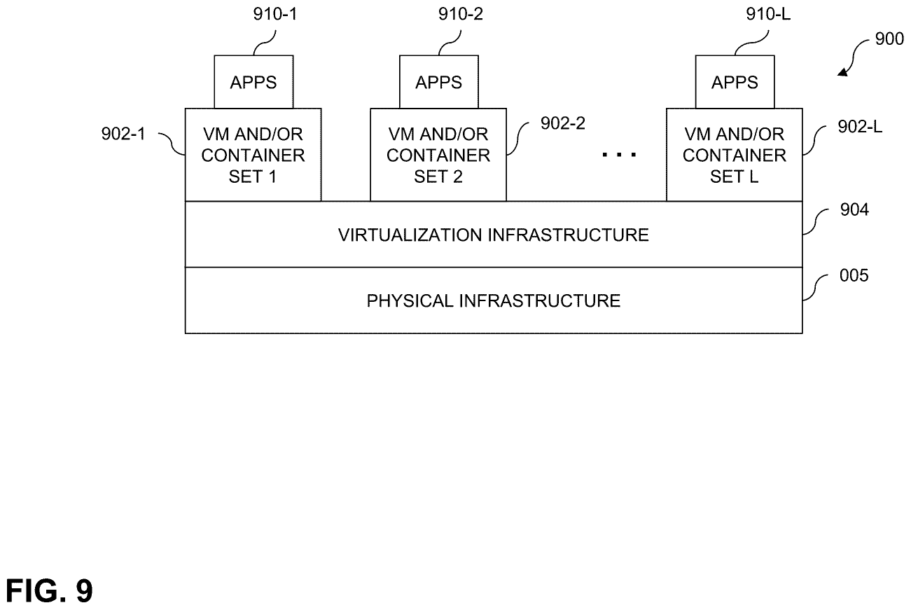

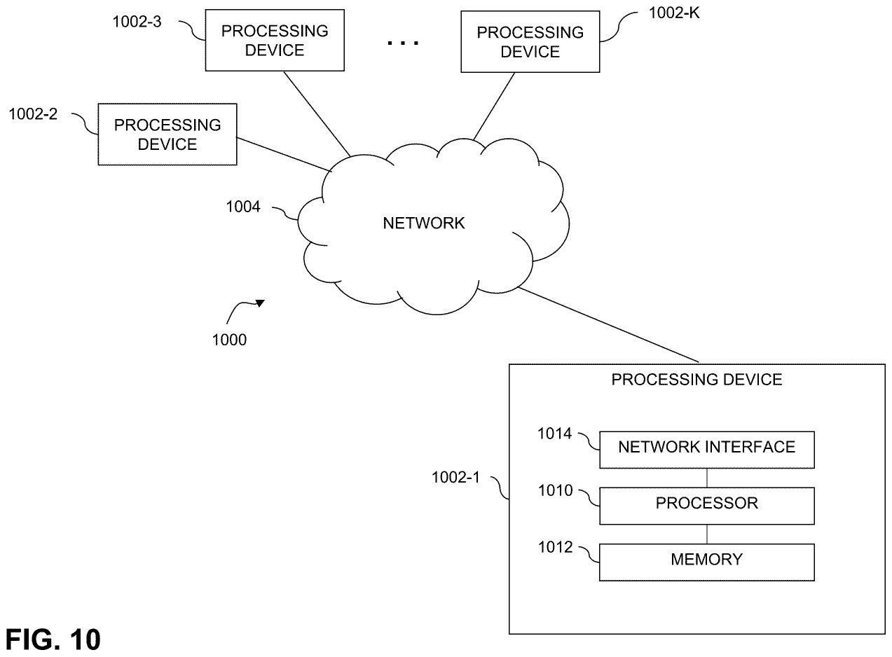

Illustrative embodiments of processing platforms will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, wherein the hypervisor platform has an associated virtual infrastructure management system. The underlying physical machines comprise one or more information processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 1012 comprises RAM, ROM or other types of memory, in any combination.

The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
encoding one or more image-related features by processing one or more portions of input image data using at least one multi-channel image encoder;
encoding one or more audio-related features by processing one or more portions of input audio data using at least one audio encoder;
encoding one or more text-related features by processing one or more portions of input text data using at least one text encoder; and
generating at least one image-based avatar by processing, using at least one vision encoder, at least a portion of the one or more image-related features and one or more of at least a portion of the one or more audio-related features and at least a portion of the one or more text-related features;
wherein the method is performed by at least one processing device comprising a processor coupled to a memory.

2. The computer-implemented method of claim 1, wherein encoding one or more image-related features comprises processing one or more portions of input image data using, as part of the at least one multi-channel image encoder, one or more red-green-blue (RGB) modality (RGBM) techniques, one or more high-frequency image modality (HFIM) techniques, and one or more attention-guided feature learning techniques.

3. The computer-implemented method of claim 2, wherein processing one or more portions of input image data using one or more RGBM techniques comprises learning one or more content-related features of the one or more portions of input image data using at least one convolutional neural network (CNN).

4. The computer-implemented method of claim 2, wherein processing one or more portions of input image data using one or more HFIM techniques comprises learning one or more high-frequency features of the one or more portions of input image data by filtering the one or more portions of input image data using at least one constraint convolutional layer and extracting one or more prediction errors based at least in part on the filtering of the one or more portions of input image data.

5. The computer-implemented method of claim 2, wherein processing one or more portions of input image data using one or more attention-guided feature learning techniques comprises learning one or more tampering artifacts in the one or more portions of input image data by processing the one or more portions of input image data using at least one convolutional block attention module (CBAM) in conjunction with one or more spatial attention processes and one or more channel attention processes.

6. The computer-implemented method of claim 1, wherein encoding one or more audio-related features comprises processing the one or more portions of input audio data using at least one one-dimensional (1D) convolution layer and multiple convolution blocks, wherein each of the multiple convolution blocks comprises one or more residual units, containing one or more dilated convolutions with one or more dilation rates, and at least one down-sampling layer comprising a strided convolution.

7. The computer-implemented method of claim 1, wherein encoding one or more text-related features comprises converting at least part of the one or more portions of input text data into one or more numeric representations using at least one recurrent neural network-based (RNN-based) encoder.

8. The computer-implemented method of claim 1, wherein generating at least one image-based avatar comprises:
processing, at least a portion of the one or more image-related features and one or more of at least a portion of the one or more audio-related features and at least a portion of the one or more text-related features, using at least one transformer decoder to generate at least one image code; and
generating at least one output image comprising at least a portion of the at least one image-based avatar by processing the at least one image code using at least one discrete variational autoencoder (DVAE) decoder.

9. The computer-implemented method of claim 1, further comprising:
concatenating, into at least one matrix, at least a portion of the one or more image-related features, at least a portion of the one or more audio-related features and at least a portion of the one or more text-related features; and
wherein generating at least one image-based avatar comprises processing the at least one matrix using the at least one vision encoder.

10. The computer-implemented method of claim 1, further comprising:
performing one or more automated actions based at least in part on the at least one image-based avatar.

11. The computer-implemented method of claim 10, wherein performing one or more automated actions comprises automatically training, using feedback related to the at least one image-based avatar, at least a portion of one or more of the at least one multi-channel image encoder, the at least one audio encoder, the at least one text encoder, and the at least one vision encoder.

12. The computer-implemented method of claim 10, wherein performing one or more automated actions comprises automatically transmitting the at least one image-based avatar to at least one user device associated with one or more of the input image data, the input audio data, and the input text data.

13. A non-transitory processor-readable storage medium having stored therein program code of one or more software programs, wherein the program code when executed by at least one processing device causes the at least one processing device:
to encode one or more image-related features by processing one or more portions of input image data using at least one multi-channel image encoder;
to encode one or more audio-related features by processing one or more portions of input audio data using at least one audio encoder;
to encode one or more text-related features by processing one or more portions of input text data using at least one text encoder; and
to generate at least one image-based avatar by processing, using at least one vision encoder, at least a portion of the one or more image-related features and one or more of at least a portion of the one or more audio-related features and at least a portion of the one or more text-related features.

14. The non-transitory processor-readable storage medium of claim 13, wherein encoding one or more image-related features comprises processing one or more portions of input image data using, as part of the at least one multi-channel image encoder, one or more red-green-blue (RGB) modality (RGBM) techniques, one or more high-frequency image modality (HFIM) techniques, and one or more attention-guided feature learning techniques.

15. The non-transitory processor-readable storage medium of claim 13, wherein encoding one or more audio-related features comprises processing the one or more portions of input audio data using at least one one-dimensional (1D) convolution layer and multiple convolution blocks, wherein each of the multiple convolution blocks comprises one or more residual units, containing one or more dilated convolutions with one or more dilation rates, and at least one down-sampling layer comprising a strided convolution.

16. The non-transitory processor-readable storage medium of claim 13, wherein generating at least one image-based avatar comprises:
processing, at least a portion of the one or more image-related features and one or more of at least a portion of the one or more audio-related features and at least a portion of the one or more text-related features, using at least one transformer decoder to generate at least one image code; and
generating at least one output image comprising at least a portion of the at least one image-based avatar by processing the at least one image code using at least one discrete variational autoencoder (DVAE) decoder.

17. An apparatus comprising:
at least one processing device comprising a processor coupled to a memory;
the at least one processing device being configured:
to encode one or more image-related features by processing one or more portions of input image data using at least one multi-channel image encoder;
to encode one or more audio-related features by processing one or more portions of input audio data using at least one audio encoder;
to encode one or more text-related features by processing one or more portions of input text data using at least one text encoder; and
to generate at least one image-based avatar by processing, using at least one vision encoder, at least a portion of the one or more image-related features and one or more of at least a portion of the one or more audio-related features and at least a portion of the one or more text-related features.

18. The apparatus of claim 17, wherein encoding one or more image-related features comprises processing one or more portions of input image data using, as part of the at least one multi-channel image encoder, one or more red-green-blue (RGB) modality (RGBM) techniques, one or more high-frequency image modality (HFIM) techniques, and one or more attention-guided feature learning techniques.

19. The apparatus of claim 17, wherein encoding one or more audio-related features comprises processing the one or more portions of input audio data using at least one one-dimensional (1D) convolution layer and multiple convolution blocks, wherein each of the multiple convolution blocks comprises one or more residual units, containing one or more dilated convolutions with one or more dilation rates, and at least one down-sampling layer comprising a strided convolution.

20. The apparatus of claim 17, wherein generating at least one image-based avatar comprises:
processing, at least a portion of the one or more image-related features and one or more of at least a portion of the one or more audio-related features and at least a portion of the one or more text-related features, using at least one transformer decoder to generate at least one image code; and
generating at least one output image comprising at least a portion of the at least one image-based avatar by processing the at least one image code using at least one discrete variational autoencoder (DVAE) decoder.
